(19) United States
(12) Patent Application Publication
(10) Pub. No.: US 2005/0242073 A1
(43) Pub. Date: Nov. 3, 2005

(54) Laser beam processing method

(75) Inventors: Masaru Nakamura, Tokyo (JP); Noboru Takeda, Tokyo (JP)

Correspondence Address: SMITH, GAMBRELL & RUSSELL, LLP, 1850 M STREET, N.W., SUITE 800, WASHINGTON, DC, 20036, US

(73) Assignee: Disco Corporation

(21) Appl. No.: 11/114,072

(22) Filed: Apr. 26, 2005

(30) Foreign Application Priority Data
Apr. 28, 2004 (JP) 2004-132671

(51) Int. Cl. B23K 26/38

(52) U.S. Cl. 219/121.72

(57) ABSTRACT

A laser beam processing method for cutting a workpiece by moving the workpiece relative to a laser beam application means while a laser beam is applied to the workpiece by the laser beam application means, comprising the steps of: bonding a protective sheet having processing resistance to the energy of the peripheral area of the laser beam to the surface to be processed of the workpiece by a water-soluble adhesive; moving the workpiece relative to the laser beam application means while the laser beam is applied to the workpiece through the protective sheet; and removing the protective sheet after the laser beam application step.

### FIELD OF THE INVENTION

The present invention relates to a laser beam processing method for carrying out predetermined processing by applying a laser beam to a predetermined area of a workpiece.

### DESCRIPTION OF THE PRIOR ART

In the production process of a semiconductor device, a plurality of areas are sectioned by dividing lines called “streets” arranged in a lattice pattern on the front surface of a substantially disk-like semiconductor wafer, and a circuit such as IC, LSI or the like is formed in each of the sectioned areas. Individual semiconductor chips are manufactured by cutting this semiconductor wafer along the dividing lines to divide it into respective areas in which the circuit is formed thereon. An optical device wafer comprising gallium nitride-based compound semiconductors and the like laminated on the front surface of a sapphire substrate is also cut along dividing lines to be divided into individual optical devices such as light emitting diodes or laser diodes, and the optical devices are widely used in electric equipment.

Cutting along the dividing lines of the above semiconductor wafer or optical device wafer is generally carried out by using a cutting machine called “dicer”. This cutting machine comprises a chuck table for holding a workpiece such as a semiconductor wafer or optical device wafer, a cutting means for cutting the workpiece held on the chuck table, and a cutting-feed means for moving the chuck table and the cutting means relative to each other. The cutting means has a spindle unit that comprises a rotary spindle, a cutting blade mounted onto the spindle and a drive mechanism for rotary-driving the rotary spindle. The cutting blade comprises a disk-like base and an annular cutting-edge that is mounted onto the side wall peripheral portion of the base and formed as thick as about 20 μm by fixing diamond abrasive grains having a diameter of about 3 μm to the base by electroforming.

Since a sapphire substrate, silicon carbide substrate, etc. have high Mohs hardness, cutting with the above cutting blade is not always easy. Further, as the cutting blade has a thickness of about 20 μm, the dividing lines for sectioning devices must have a width of about 50 μm. Therefore, in the case of a device measuring 300 μm×300 μm, the area ratio of the streets to the wafer becomes 14%, thereby reducing productivity.

Meanwhile, a processing method for cutting a workpiece such as a semiconductor wafer or the like by applying a laser beam along dividing lines of the semiconductor wafer is also attempted and disclosed by JP-A 6-120334.

When a laser beam is applied along the dividing lines of the semiconductor wafer, however, heat energy is concentrated on an area to which the laser beam has been applied, to produce debris that adhere to a bonding pad connected to a circuit, thereby deteriorating semiconductor chips.

To solve the above problem, the inventors of the present invention conducted experiments on the application of a laser beam LB to a workpiece W through a protective sheet S, which is prepared by coating a vinyl chloride sheet with an acrylic adhesive and is in advance mounted on the surface to be processed, of the workpiece W, as shown in FIG. 10(a).

Although the adhesion of debris to the surface to be processed is prevented by mounting the protective sheet S on the surface to be processed of the workpiece W, debris D accumulated on both sides of a processing groove G as shown in FIG. 10(b) are not completely removed. Further, a new problem arises that the acrylic adhesive firmly adheres to both sides of the processing groove G. It is considered that this is caused because the protective sheet S on both sides of the processing groove G is molten by the heat energy of the laser beam.

### SUMMARY OF THE INVENTION

It is an object of the present invention to provide a laser beam processing method capable of preventing the influence of debris produced by applying a laser beam to a workpiece.

According to the present invention, the above object of the present invention is attained by a laser beam processing method for cutting a workpiece by moving the workpiece relative to a laser beam application means while a laser beam is applied to the workpiece by the laser beam application means, which comprises:
a protective sheet mounting step for bonding a protective sheet having processing resistance to energy, which the peripheral area has, of the laser beam to a surface to be processed of the workpiece by a water-soluble adhesive;
a laser beam application step for moving the workpiece relative to the laser beam application means while the laser beam is applied to the workpiece through the protective sheet; and
a protective sheet removal step for removing the protective sheet after the laser beam application step.

The above protective sheet is preferably a metal foil, especially preferably an aluminum foil. In the above protective sheet removal step, the protective sheet is removed together with the adhesive by supplying water to the workpiece.

In the laser beam processing method of the present invention, as a laser beam is applied to the workpiece through the protective sheet, which is bonded to the surface to be processed of the workpiece by a water-soluble adhesive and has processing resistance to the energy, which the peripheral area has, of the laser beam, a processing groove is formed by the central area having high energy of the laser beam, and the peripheral area having low energy of the laser beam is blocked off by the protective sheet. As a result, the adhesive between the protective sheet and the workpiece on both sides of the processing groove is not molten, whereby debris (molten droplets), which are produced by forming the processing groove with the central area of the laser beam, adhere to the top surface of the protective sheet but do not accumulate on the front surface on both sides of the processing groove of the workpiece. Further, in the laser beam processing method according to the present invention, the peripheral area of the laser beam is blocked off by the protective sheet as described above and hence, the laser beam having reduced impact force is applied to the workpiece. Consequently, both sides of the processing groove are hardly cracked, thereby improving the breaking strength of the obtained chips. Further, since the protective sheet is bonded to the semiconductor wafer by the water-soluble adhesive, it can be washed off with water, thereby making it extremely easy to remove the protective sheet.

### BRIEF DESCRIPTION OF THE DRAWINGS

FIG. 1 is a perspective view of a laser beam processing machine used to carry out the laser beam processing method of the present invention;

FIG. 2 is a block diagram schematically showing the constitution of a laser beam processing means provided in the laser beam processing machine shown in FIG. 1;

FIG. 3 is a schematic diagram explaining the focusing spot diameter of a laser beam applied from the laser beam processing means shown in FIG. 2;

FIG. 4 is a perspective view of a semiconductor wafer as a workpiece to be processed by the laser beam processing method of the present invention;

FIG. 5 is a perspective view of the semiconductor wafer supported to an annular frame by a protective tape;

FIG. 6 is an explanatory diagram showing a protective sheet mounting step in the laser beam processing method of the present invention;

FIG. 7 is an explanatory diagram showing a laser beam application step in the laser beam processing method of the present invention;

FIG. 8 is an explanatory diagram showing s state where the semiconductor wafer as the workpiece is processed in the laser beam application step shown in FIG. 7;

FIG. 9 is a sectional view of the principal section of the semiconductor wafer as the workpiece divided into individual chips by the laser beam processing method of the present invention; and

FIGS. 10(a) and 10(b) are explanatory diagrams showing an example of the laser beam processing method of the prior art.

### DETAILED DESCRIPTION OF THE PREFERRED EMBODIMENT

A preferred embodiment of the present invention will be described in detail hereinunder with reference to the accompanying drawings.

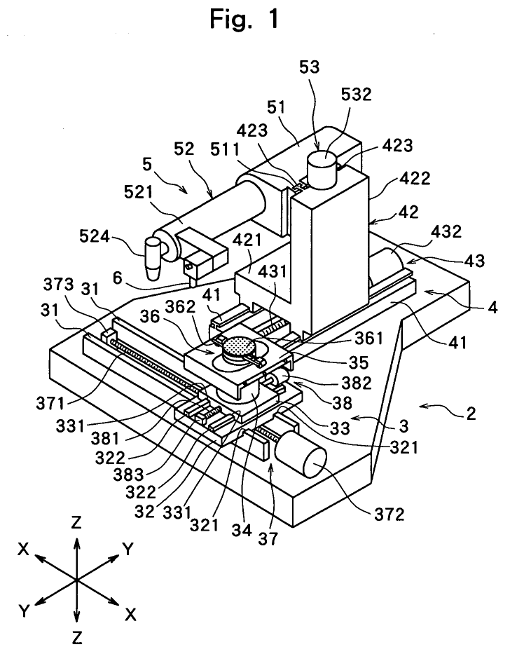

FIG. 1 is a perspective view of a laser beam processing machine for applying a laser beam to a workpiece such as a semiconductor wafer or the like in the laser beam processing method of the present invention. The laser beam processing machine shown in FIG. 1 comprises a stationary base 2, a chuck table mechanism 3 for holding a plate-like workpiece, which is mounted on the stationary base 2 in such a manner that it can move in a direction indicated by an arrow X, a laser beam application unit support mechanism 4 mounted on the stationary base 2 in such a manner that it can move in a direction indicated by an arrow Y perpendicular to the direction indicated by the arrow X, and a laser beam application unit 5 mounted to the laser beam application unit support mechanism 4 in such a manner that it can move in a direction indicated by an arrow Z.

The above chuck table mechanism 3 comprises a pair of guide rails 31 and 31 that are mounted on the stationary base 2 and arranged parallel to each other in the direction indicated by the arrow X, a first sliding block 32 mounted on the guide rails 31 and 31 in such a manner that it can move in the direction indicated by the arrow X, a second sliding block 33 mounted on the first sliding block 32 in such a manner that it can move in the direction indicated by the arrow Y, a support table 35 supported on the second sliding block 33 by a cylindrical member 34, and a chuck table 36 as a workpiece holding means. This chuck table 36 comprises an adsorption chuck 361 made of a porous material so that a disk-like semiconductor wafer as the workpiece is held on the adsorption chuck 361 by a suction means that is not shown. The chuck table 36 is rotated by a pulse motor (not shown) installed in the cylindrical member 34. The chuck table 36 is provided with clamps 362 for fixing an annular frame that will be described later.

The above first sliding block 32 has, on its undersurface, a pair of to-be-guided grooves 321 and 321 to be fitted to the above pair of guide rails 31 and 31 and has, on its top surface, a pair of guide rails 322 and 322 formed parallel to each other in the direction indicated by the arrow Y. The first sliding block 32 constituted as described above is so constituted to be moved in the direction indicated by the arrow X along the pair of guide rails 31 and 31 by fitting the to-be-guided grooves 321 and 321 to the pair of guide rails 31 and 31, respectively. The chuck table mechanism 3 in the illustrated embodiment has a moving means 37 for moving the first sliding block 32 along the pair of guide rails 31 and 31 in the direction indicated by the arrow X. The moving means 37 comprises a male screw rod 371 that is arranged between the above pair of guide rails 31 and 31 in parallel to them, and a drive source such as a pulse motor 372 for rotary-driving the male screw rod 371. The male screw rod 371 is, at its one end, rotatably supported to a bearing block 373 fixed on the above stationary base 2 and is, at its other end, transmission-connected to the output shaft of the above pulse motor 372 by a speed reducer that is not shown. The male screw rod 371 is screwed into a threaded through-hole formed in a female screw block (not shown) projecting from the undersurface of the center portion of the first sliding block 32. Therefore, by driving the male screw rod 371 in a normal direction or reverse direction with the pulse motor 372, the first sliding block 32 is moved along the guide rails 31 and 31 in the direction indicated by the arrow X.

The above second sliding block 33 has, on its undersurface, a pair of to-be-guided grooves 331 and 331 to be fitted to the pair of guide rails 322 and 322 on the top surface of the above first sliding block 32, and is so constituted to be moved in the direction indicated by the arrow Y by fitting the to-be-guided grooves 331 and 331 to the pair of guide rails 322 and 322, respectively. The chuck table mechanism 3 in the illustrated embodiment has a moving means 38 for moving the second sliding block 33 in the direction indicated by the arrow Y along the pair of guide rails 322 and 322 on the first sliding block 32. The moving means 38 comprises a male screw rod 381 which is arranged between the above pair of guide rails 322 and 322 in parallel to them, and a drive source such as a pulse motor 382 for rotary-driving the male screw rod 381. The male screw rod 381 is, at its one end, rotatably supported to a bearing block 383 fixed on the top surface of the above first sliding block 32 and is, at the other end, transmission-connected to the output shaft of the above pulse motor 382 by a speed reducer that is not shown. The male screw rod 381 is screwed into a threaded through-hole formed in a female screw block (not shown) projecting from the undersurface of the center portion of the second sliding block 33. Therefore, by driving the male screw rod 381 in a normal direction or reverse direction with the pulse motor 382, the second sliding block 33 is moved along the guide rails 322 and 322 in the direction indicated by the arrow Y.

The above laser beam application unit support mechanism 4 comprises a pair of guide rails 41 and 41 that are mounted on the stationary base 2 and arranged parallel to each other in the indexing direction indicated by the arrow Y and a movable support base 42 mounted on the guide rails 41 and 41 in such a manner that it can move in the direction indicated by the arrow Y. This movable support base 42 comprises a movable support portion 421 movably mounted on the guide rails 41 and 41 and a mounting portion 422 mounted on the movable support portion 421. The mounting portion 422 is provided with a pair of guide rails 423 and 423 extending in the direction indicated by the arrow Z on one of its flanks. The laser beam application unit support mechanism 4 in the illustrated embodiment has a moving means 43 for moving the movable support base 42 along the pair of guide rails 41 and 41 in the indexing-feed direction indicated by the arrow Y. This moving means 43 comprises a male screw rod 431 arranged between the above pair of guide rails 41 and 41 in parallel to them, and a drive source such as a pulse motor 432 for rotary-driving the male screw rod 431. The male screw rod 431 is, at its one end, rotatably supported to a bearing block (not shown) fixed on the above stationary base 2 and is, at the other end, transmission-connected to the output shaft of the above pulse motor 432 by a speed reducer that is not shown. The male screw rod 431 is screwed into a threaded through-hole formed in a female screw block (not shown) projecting from the undersurface of the center portion of the movable support portion 421 constituting the movable support base 42. Therefore, by driving the male screw rod 431 in a normal direction or reverse direction with the pulse motor 432, the movable support base 42 is moved along the guide rails 41 and 41 in the indexing-feed direction indicated by the arrow Y.

The laser beam application unit 5 in the illustrated embodiment has a unit holder 51 and a laser beam application means 52 secured to the unit holder 51. The unit holder 51 has a pair of to-be-guided grooves 511 and 511 to be slidably fitted to the pair of guide rails 423 and 423 provided on the above mounting portion 422 and is supported in such a manner that it can move in the direction indicated by the arrow Z by fitting the to-be-guided grooves 511 and 511 to the above guide rails 423 and 423, respectively.

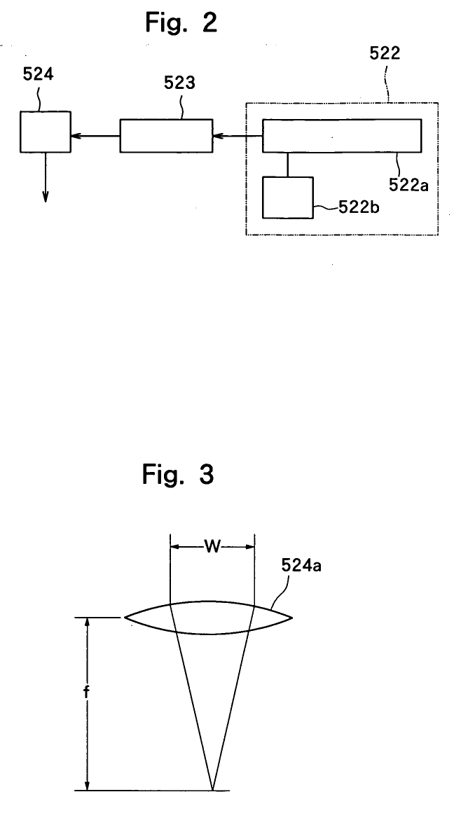

The illustrated laser beam application means 52 comprises a cylindrical casing 521 that is secured to the above unit holder 51 and extends substantially horizontally. In the casing 521, there are installed a pulse laser beam oscillation means 522 and a transmission optical system 523 as shown in FIG. 2. The pulse laser beam oscillation means 522 is constituted by a pulse laser beam oscillator 522a composed of a YAG laser oscillator or YVO4 laser oscillator and a repetition frequency setting means 522b connected to the pulse laser beam oscillator 522a. The transmission optical system 523 comprises suitable optical elements such as a beam splitter, etc. A condenser 524 housing condensing lenses (not shown) constituted by a set of lenses, of which the formation may be known per se, is attached to the end of the above casing 521.

A laser beam oscillated from the above pulse laser beam oscillation means 522 reaches the condenser 524 through the transmission optical system 523 and is applied from the condenser 524 to the workpiece held on the above chuck table 36 at a predetermined focusing spot diameter D. This focusing spot diameter D is defined by the expression D (μm)=4×λ×f/(π×W) (wherein λ is the wavelength (μm) of the pulse laser beam, W is the diameter (mm) of the pulse laser beam applied to an objective lens 524a, and f is the focusing distance (mm) of the objective lens 524a) when the pulse laser beam having a Gaussian distribution is applied through the objective lens 524a of the condenser 524 as shown in FIG. 3.

An image pick-up means 6 is mounted to the front end of the casing 521 constituting the above laser beam application means 52. This image pick-up means 6 comprises an illuminating means for illuminating the workpiece and an optical system for capturing the area illuminated by the illuminating means, in addition to an ordinary image pick-up device (CCD) for picking up an image with visible radiation and an infrared CCD for picking up an image with infrared radiation one of which can be suitably selected. An image captured by the optical system is transmitted to the image pick-up device (CCD or infrared CCD) and converted into an electric image signal which is then supplied to a control means that is not shown.

The laser beam application unit 5 in the illustrated embodiment comprises a moving means 53 for moving the unit holder 51 along the pair of guide rails 423 and 423 in the direction indicated by the arrow Z. The moving means 53 comprises a male screw rod (not shown) arranged between the pair of guide rails 423 and 423 and a drive source such as a pulse motor 532 for rotary-driving the male screw rod, like the above-described moving means. By driving the male screw rod (not shown) in a normal direction or reverse direction with the pulse motor 532, the unit holder 51 and the laser beam application means 52 are moved along the guide rails 423 and 423 in the direction indicated by the arrow Z.

A description will be subsequently given of the processing method for dividing a semiconductor wafer as the workpiece into individual semiconductor chips by using the above-described laser beam processing machine.

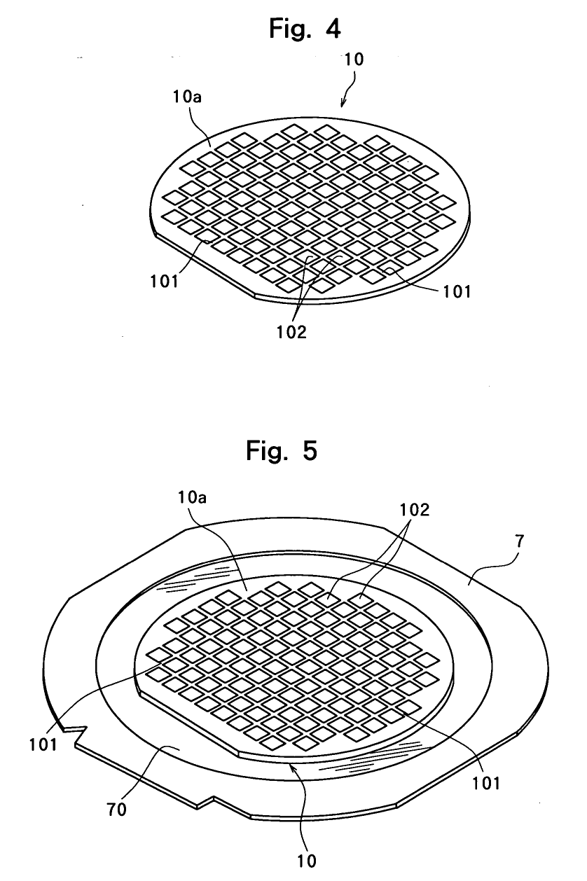

FIG. 4 shows a semiconductor wafer to be divided into individual semiconductor chips by the laser beam processing method of the present invention. The semiconductor wafer 10 shown in FIG. 4 is a silicon wafer having a thickness of 100 μm, a plurality of areas are sectioned by a plurality of streets (dividing lines) 101 formed in a lattice pattern on the front surface 10a, and a circuit 102 such as IC or LSI is formed in each of the sectioned areas. To divide this semiconductor wafer 10 into individual semiconductor chips by using the above-described laser beam processing machine, the semiconductor wafer 10 is first put on a protective tape 70 affixed to an annular frame 7 in such a manner that the back surface comes into contact with the protective tape 70 (therefore, the front surface 10a faces up) and supported to the annular frame 7, as shown in FIG. 5 (workpiece supporting step). The semiconductor wafer 10 supported to the annular frame 7 via the protective tape 70 is carried to the adsorption chuck 361 of the chuck table 36 of the laser beam processing machine shown in FIG. 1 in such a manner that the front surface 10a faces up, and suction-held on the adsorption chuck 361. The annular frame 7 supporting the semiconductor wafer 10 via the protective tape 70 is fixed on the chuck table 36 by clamps 362. The chuck table 36 thus suction-holding the semiconductor wafer 10 is moved along the guide rails 31 and 31 by the operation of the moving means 37 to be positioned right below the image pick-up means 6 installed in the laser beam application unit 5.

After the chuck table 36 is positioned right below the image pick-up means 6, the image pick-up means 6 and the control means (not shown) carry out image processing such as pattern matching, etc. to align a street 101 formed in a predetermined direction of the semiconductor wafer 10 with the condenser 524 of the laser beam application unit 5 for applying a laser beam along the street 101, thereby performing the alignment of a laser beam application position. The alignment of the laser beam application position is also similarly carried out on streets 101 formed on the semiconductor wafer 10 in a direction perpendicular to the above predetermined direction (aligning step). The laser beam application position corresponding to the streets 102 detected by carrying out the aligning steps as described above is stored in the memory of the control means that is not shown.

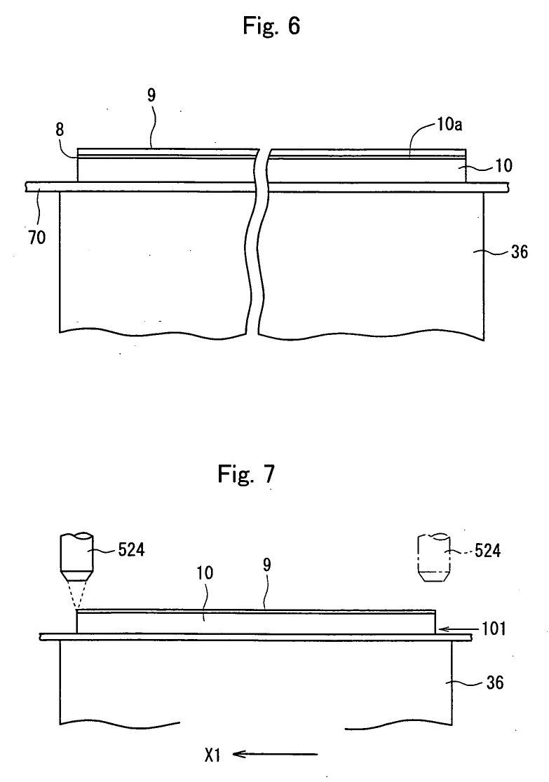

After the above aligning step, there comes the protective sheet mounting step for bonding a protective sheet having processing resistance to the energy, which the peripheral area has, of a laser beam to the surface to be processed, that is, the front surface 10a, of the semiconductor wafer 10 by a water-soluble adhesive in a state where the semiconductor wafer 10 is held on the chuck table 36. That is, as shown in FIG. 6, the water-soluble adhesive 8 formed of polyvinyl alcohol or polyethylene glycol is coated onto the front surface 10a of the semiconductor wafer 10 held on the chuck table 36 via the protective sheet 70 to bond the protective sheet 9 to the semiconductor wafer 10 by this water-soluble adhesive. A sheet member having processing resistance to the energy, which the peripheral area has, of a laser beam is used as the protective sheet 9. A metal foil, particularly an aluminum foil having a thickness of 25 μm is preferred as the sheet member having processing resistance to the energy, which the peripheral area has, of the laser beam. A polyimide resin sheet or polyether imide resin sheet having processing resistance to the energy, which the peripheral area has, of a laser beam may be used as the protective sheet 9. When a polyimide resin sheet or polyether imide resin sheet is used, the aligning step may be carried out after the protective sheet 9 is mounted, because light passes through the sheet.

After the protective sheet mounting step for bonding the protective sheet 9 to the front surface 10a of the semiconductor wafer 10 held on the chuck table 36 is carried out as described above, the chuck table 36 is moved to a laser beam application area where the condenser 524 of the laser beam application unit 5 for applying a laser beam is located. Thereafter, the laser beam processing machine carries out the laser beam application step for applying a laser beam along the street 101 of the semiconductor wafer 10 through the protective sheet 9 based on information on the laser beam application position corresponding to each street 101 stored in the memory of the control means (not shown) in the above aligning step.

The laser beam application step will be described hereinunder.

In the laser beam application step, as shown in FIG. 7, the chuck table 36 is moved to a laser beam application area where the condenser 524 of the laser beam application means 52 for applying a laser beam is located to bring one end (left end in FIG. 7) of a predetermined street 101 to a position right below the condenser 524. The chuck table 36, that is, the semiconductor wafer 10 is moved in the direction indicated by the arrow X1 in FIG. 7 at a predetermined feed rate while a pulse laser beam is applied from the condenser 524. When the application position of the condenser 524 reaches the other end (right end in FIG. 7) of the predetermined street 101, the application of the pulse laser beam is suspended and the movement of the chuck table 36, that is, the semiconductor wafer 10 is stopped. The processing conditions in the laser beam application step are set as follows, for example.
Light source: YVO4 pulse laser
Wavelength: 355 nm
Average output: 1 to 5 W
Repetition frequency: 30 to 100 kHz
Focusing spot diameter: 10 to 20 μm
Feed rate: 100 to 200 mm/sec

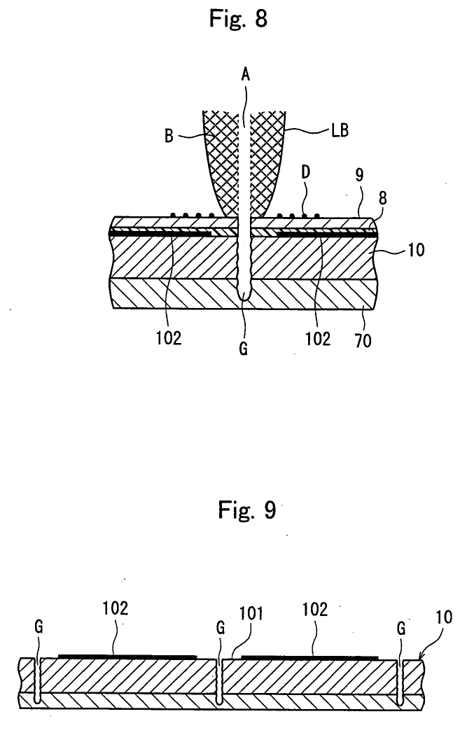

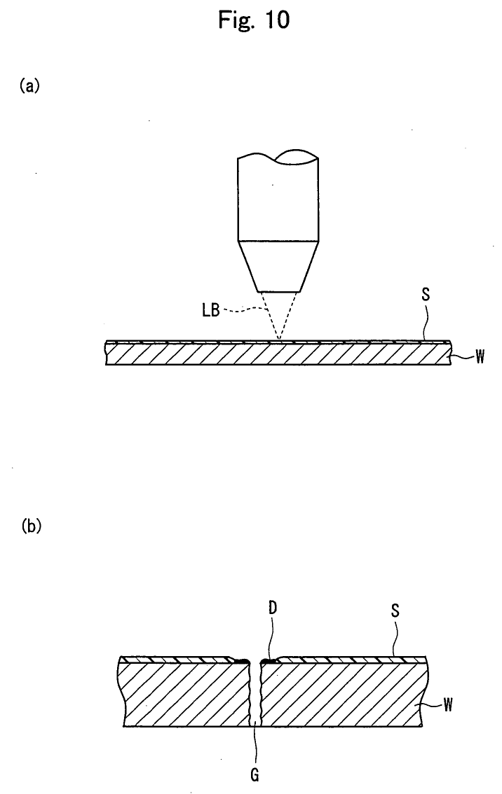

A processing groove is formed along the street 101 of the semiconductor wafer 10 by carrying out the above laser beam application step. At this moment, when a laser beam LB having a Gaussian distribution is applied as shown in FIG. 8, the center area A of the laser beam LB has high energy, the processing groove G is formed in the protective sheet 9, adhesive 8 and semiconductor wafer 10 by the center area A of the laser beam LB. Meanwhile, since the peripheral area B of the laser beam LB has lower energy than the center area A, the protective sheet 9 having processing resistance to the energy of the peripheral area of the laser beam cannot be processed. As a result, the adhesive 8 between the protective sheet 9 and the semiconductor wafer 10 is not molten on both sides of the processing groove G. Therefore, debris (molten droplets) D produced by forming the processing groove G with the center area A of the laser beam LB adheres to the top surface of the protective sheet 9 but does not accumulate on the front surface on both sides of the processing groove G of the semiconductor wafer 10 and does not adhere to the circuit 102 and the bonding pad, etc. Further, since the peripheral area B of the laser beam LB is blocked off by the protective sheet 9 as described above to reduce its impact force and then applied to the semiconductor wafer 10, both sides of the processing groove G are hardly cracked, thereby improving the breaking strength of the obtained chips.

After the laser beam application step is carried out on the predetermined street as described above, the chuck table 36, that is, the semiconductor wafer 10 held on the chuck table 36 is moved in the indexing direction indicated by the arrow Y by the distance between streets (indexing step) and then, the above laser beam application step is carried out. After the laser beam application step and the indexing step are carried out on all of the streets extending in the predetermined direction as described above, the chuck table 36, that is, the semiconductor wafer 10 held on the chuck table 36 is turned at 90° and subsequently, the above laser beam application step and the indexing step on streets 101 extending in a direction perpendicular to the above predetermined direction are carried out to divide the semiconductor wafer 10 into individual semiconductor chips. After the semiconductor wafer 10 is thus divided into individual semiconductor chips, the chuck table 36 holding the semiconductor wafer 20 is returned to the position where it first suction-held the semiconductor wafer 10 to cancel the suction-holding of the semiconductor wafer 10. The semiconductor wafer 10 is then carried to the subsequent step by a conveying means that is not shown.

Next comes the step of removing the protective sheet 9 bonded to the front surface 10a of the semiconductor wafer 10. In this protective sheet removal step, as the adhesive 8 is composed of a water-soluble resin as described above, the protective sheet 9 can be washed off with water. At this moment, debris D that have been produced in the above laser beam application step and have adhered to the front surface of the protective sheet 9 are washed off together with the protective sheet 9. As a result, the semiconductor wafer 10 is divided into individual semiconductor chips along the streets 101 as shown in FIG. 9. Since the protective sheet 9 is bonded to the semiconductor wafer 10 by the water-soluble adhesive 8, it can be washed off with water, thereby making it extremely easy to remove the protective sheet 9.

The present invention has been described based on the embodiment in which a semiconductor wafer formed of a silicon wafer is divided. The present invention can be applied to laser beam processing for other workpiece such as a glass wafer, gallium arsenic wafer, sapphire wafer or lithium tantalite wafer. The present invention can be applied also in a case where a Low-k film or Teg on the street is removed from a semiconductor wafer in a form of laminating a low-dielectric insulating film (Low-k film) formed of a film of an inorganic material such as SiOF or BSG (SiOB) or a film of an organic material such as a polyimide-based or parylene-based polymer on the front surface of a semiconductor substrate such as a silicon wafer, or from a semiconductor wafer having a metal pattern called “test element group (Teg)”.

1. A laser beam processing method for cutting a workpiece by moving the workpiece relative to a laser beam application means while a laser beam is applied to the workpiece by the laser beam application means, comprising the steps of:
a protective sheet mounting step for bonding a protective sheet having processing resistance to the energy of the peripheral area of the laser beam to the surface to be processed of the workpiece by a water-soluble adhesive;
a laser beam application step for moving the workpiece relative to the laser beam application means while the laser beam is applied to the workpiece through the protective sheet; and
a protective sheet removal step for removing the protective sheet after the laser beam application step.

2. The laser beam processing method according to claim 1, wherein the protective sheet is a metal foil.

3. The laser beam processing method according to claim 2, wherein the metal foil forming the protective sheet is an aluminum foil.

4. The laser beam processing method according to claim 1, wherein the protective sheet is removed together with the adhesive by supplying water to the workpiece in the protective sheet removal step.
